(19) United States
(12) Patent Application Publication
(10) Pub. No.: US 2021/0191695 A1
(43) Pub. Date: Jun. 24, 2021

(54) METHOD AND SYSTEM FOR EXECUTING MULTI-DIMENSIONAL DATA QUERIES

(71) Applicant: Mirage 3.4D Pty Ltd, Sydney (AU)

(72) Inventor: Maryanne Lynch, Elizabeth Bay (AU)

(21) Appl. No.: 17/056,757

(22) PCT Filed: May 17, 2019
(86) PCT No.: PCT/AU2019/050473

§ 371 Date: Nov. 18, 2020

(30) Foreign Application Priority Data
May 18, 2018 (AU) 2018901747

(51) Int. Cl. G06F 8/35; G06F 16/28; G06F 16/22; G06F 8/20

(52) U.S. Cl. CPC G06F 8/35; G06F 8/20; G06F 16/2264; G06F 16/283

(57) ABSTRACT

A software object model for use in programming or operating system environment, the object model including: a multi-dimensional coordinate system, where the coordinates may be object instances rather than numeric axis values. Also provided is a method for constructing and handling hierarchical name spaces that allows for advanced key generation functions which can be matched with the processor bus width for improved computing efficiency, with the object model's key storage allowing for lookups to be done via number rather than text. Further provided is a multidimensional data rendering system where dimensions are superimposed on axes for viewing, making it easier to create multidimensional audio/visual representations of abstract structures.

### FIELD OF THE INVENTION

The present invention provides for systems and methods for the development of an efficient modular model based operating system or programming environment utilising a semantic multidimensional coordinate system for operating on software object models.

### BACKGROUND OF THE INVENTION

Any discussion of the background art throughout the specification should in no way be considered as an admission that such art is widely known or forms part of common general knowledge in the field.

With the increasing rise in complexity of the operation of computer resources, there is a significant need for a modular model based programming environment with a semantic coordinate system for the effective utilization of such resources.

Further, there is a general need for simple models for model based composable code generation. U.S. Pat. No. 7,219,328, to Schloegel et al, entitled “Model-Based Composable Code Generation”, the contents of which are hereby specifically incorporated by cross reference, outlines one framework for generating code for the model based development of a system.

Such arrangements are unsuitable when there are a large number of class objects to deal with in a programming environment.

### BACKGROUND REFERENCES

Gamma et al., “Design Patterns: Element of Reusable Object-oriented Software”, Addison-Wesley, 1995, pp. 163-173.
Russell et al., “Artificial Intelligence: A Modern Approach”, Prentice-Hall, 1995, pp. 316-323.
Oglesby et al., “A Pattern-based Framework to Address Abstraction, Reuse, and Cross-domain Aspects in Domain Specific Visual Languages”, Proceedings of OOPSLA, 2001.
Ledeczi et al., “On Metamodel Composition”, Institute for Software Integrated Systems, IEEE CCA, Sep. 5, 2001, 5 pgs.
Kaashock, m. F. & Karger, D. R., “Koorde: A simple degree-optimal distributed hash table”, IPTPS, 2003.
Dabek, F., “A Distributed Hash Table”, PhD thesis, Massachusetts Institute of Technology, M A., 2005.
“OMG® Unified Modeling Language® (OMG UML®) Version 2.5.1”, Object Management Group, Inc., 2017, p. 155.
http://blog.leapmotion.com/truly-3d-operating-system-look-like/

### SUMMARY OF THE INVENTION

It is an object of the invention, in its preferred form to provide for the development of an efficient modular model based programming or operating system environment utilising a semantic multidimensional coordinate system for operating on software object models.

In accordance with a first aspect of the present invention, there is provided a software object model for use in a programming or operating system environment, the object model including: a multi-dimensional coordinate system, where the coordinates may be object instances rather than numeric axis values.

In some embodiments, the coordinates intersect at a Place, and the intersection of the coordinates at the Place forms a unique key which may be used to reference objects at that address quickly and uniformly. Access to the objects can be via a hierarchical name space with the coordinate axes forming the hierarchy of the name space.

In some embodiments, the multi-dimensional coordinate system preferably can include at least 1 axis.

In accordance with a further aspect of the present invention, there is provided a multidimensional data visualization system where dimensions (two or more) are superimposed on axes for user consumption, making it easier to create multidimensional audio/visual representations of abstract structures.

In accordance with a further aspect of the present invention, there is provided a method of creating an executable software object model including defined objects and instances for execution within a data container in a software environment, the method including the steps of: (a) creating a first software object instance having a unique place key (or keys), (b) creating a subsequent instance based on the first software instance by utilisation of the place key; (c) storing the first and subsequent instances at positions utilising the place key; and (d) creating further data instances, in a current data container, and if a predetermined criterion applies, creating an instance with the place key in the current data container or an alternative data container.

In some examples, instances are matched at a place key location, where the place key location is at the intersection of two or more axis.

In accordance with a further aspect of the present invention, there is provided a software execution environment including a multidimensional coordinate system for software object models, where the coordinates intersections locate object instances, for access and execution.

This invention provides an efficient key system for data structures which are used in one or more multidimensional containers.

Some example dimensions include: “Device”, “User, “Application”, “Version”, “Session”; where each is an object with a unique key, which is a parameter in forming one or more place keys.

A semantic multidimensional coordinate system for software object models provides a construct to create and handle hierarchical name spaces in multidimensions, whilst also providing a rendering system to create audio/visual representations of software object models in multidimensions.

One or more dimensions can be selected to create Axes for a grid in a context. One or more dimensions may be selected to create an axis for animating objects in the grid over time. The dimensions are superimposed on axes to create visual representations of object models; with the remaining dimension values stored as constants in the grid context. When an axis origin and block size is provided, one or more grid(s) may be calculated in Euclidean space.

Each dimension is mutually exclusive to each other dimension when composition links are used.

In Unified Modelling Language (UML), when an object instance has a composite association, the target is assumed to be part of the source dimension.

In UML, when an object instance has an aggregate association, the target of the association is assumed to be part of another dimension tree.

Under these rules, a modern applications tend to have 10 well known dimensions which intersect to form Places, where a block of user data is located. In a 2D view, 2 dimensions are visible and 8 other dimensions are provided by the model. In a 3D view, 3 are visible and 7 other dimensions are provided by the model.

### BRIEF DESCRIPTION OF THE DRAWINGS

Embodiments of the invention will now be described, by way of example only, with reference to the accompanying drawings in which:

FIG. 1 is an UML Class Diagram of an embodiment showing a typical object structure which implements the embodiment; and

FIG. 2 provides an example source code listing for key formation in accordance with an embodiment.

### DETAILED DESCRIPTION

Example embodiments relate to a semantic multidimensional coordinate system for software object models for providing a multi-dimensional coordinate system, where the coordinates may be object instances rather than numeric axis values. The coordinates intersect at a Place, and the intersection of the coordinates at the Place forms a unique key which may be used to reference objects at that address quickly and uniformly.

The embodiments come about from the need to construct hierarchical name spaces. There is a natural multi-dimensional set of axes that tends to run through the data and the embodiments provide a simple way to represent this. As data systems become larger, an organisational method is required and the embodiments provide an axis based modelling. The axis can be hierarchical structures.

In order to create an axis there are rules, only certain types of objects will fit the criteria to be part of an axis. Any data that doesn't fit the criteria to become an axis becomes part of the content of the model.

The location of two or more axes intersect forms a place and key, which is more or less a node in a graph. The node has an additional level of indirection, whereby the content instantiated in the place maybe swapped for another instance.

Context: A model always has context, which is essentially the volume the model is in. This can include a Parent model, which provides constant axis values for child models, thereby simplifying the logic in the child model. This allows the child model to have smaller keys, which require less data.

Aggregation and Composition are concepts that are implemented in the preferred embodiment system. Aggregation provides for separation where objects are not part of the same axis and composition provides for axis blocks that must be composed and cannot be aggregated. Aggregation and composition links can be used to analyse a system. From viewing the results, one can determine if the data has natural intersections. In one embodiment, it is possible to use composition only, and not use elements which are aggregated, on the same axis. This is similar to the slot version provided in UML version 2.4.

Large Data Sets: The embodiments may be applied as a stand-alone concept on top of large data sets. This can be achieved via the steps of: 1) Import data source; 2) Analyse the objects according to any provided rules; 3) Impose an axis system; 4) Analyse data as model units. When analysing very large volumes of data, the embodiments allow users to comprehend the data in a much faster way.

The embodiments can have application in Data visualization systems, Data query systems, the storage and retrieval of records and merging data sets. The embodiments provide for a simple system for creation of 2D, 3D, and 4D representations of data structures, creating a strong spatial system that allows for dynamic data dimensionality. The spatial semantics and dimensionality allows the user to comprehend the data that they are using. The data organization saves the user from losing data due to disorganization and provides a sematic grid system.

The embodiments provide a consistent axis system for including one or more axes in multiple dimensions and superimposing one dimension on another. Additional advantages include a system which authors data that is compatible in n-dimensions and consistent throughout; provides consistent user interaction across 1D, 2D, 3D, 4D, 5D; provides a standard category system among users; provides a data definition technique for n-dimensions; provides catalogues, a unique identifier, for identifying records; provides a flexible convention for creating and handling addresses in n-dimensional spaces which are unique yet merge without conflict; and provides increased processing speed by querying via a number as opposed to querying via text.

The embodiments provide a semantic multidimensional coordinate system for software object models. This includes providing a semantic multidimensional coordinate system for software object models, where the coordinates may be object instances rather than numeric axis values. The coordinates intersect at a Place, and the intersection of the coordinates at the Place forms a unique key which may be used to reference objects at that address quickly and uniformly. This includes allowing Software Object Models that allows for non-traditional axes and dimensions by allowing the user to define their own axes in a Model.

The system uses the intersections of axis positions to create an address and a key which is used for looking up object instances in a model.

In some examples, the users can specify positions by name or URL, as opposed to using numeric coordinates.

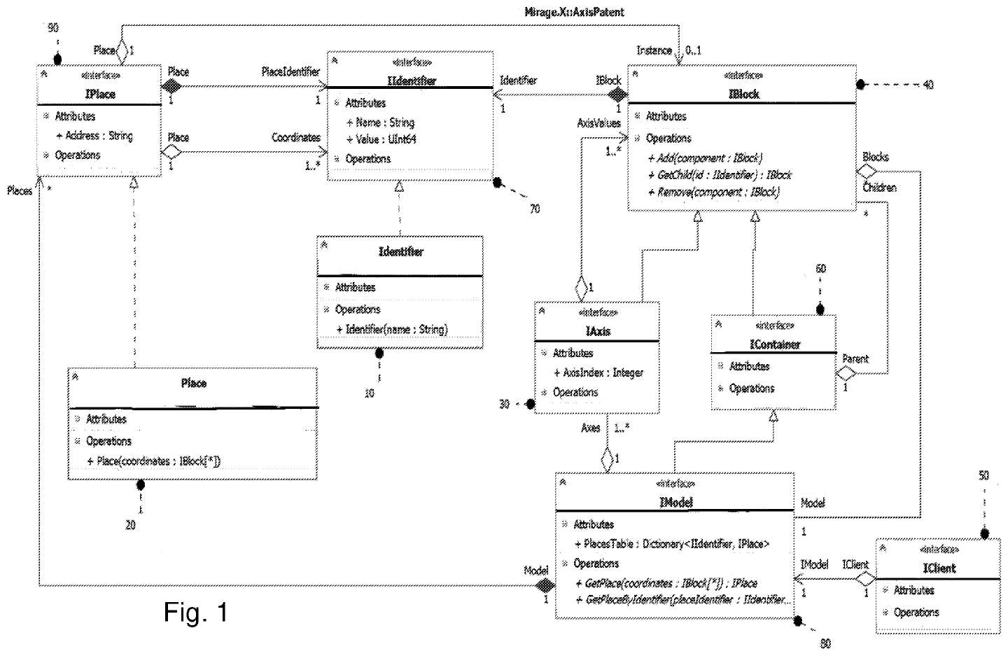

Turning now to FIG. 1 there is illustrated a model object diagram comprising a set of interfaces including IPlace 90, IIdentifier 70, IBlock 40, IClient 50, IAxis 30, IContainer 60, IModel 80 and two classes named Place 20 and Identifier 10, which implement the IPlace and IIdentifier interfaces respectively.

The objects include:

Identifier 70: An immutable class that implements the IIdentifier interface. There are no variations of this element.

Place 90: An immutable class that implements the IPlace interface. There are no variations of this element.

IAxis 30: The IAxis interface is a type of IBlock, where the AxisValues collection contains IBlock instances, where the blocks may serve as axis values in a coordinate system. There are no variations of this element.

IBlock 40: The IBlock interface is a derivative of Component, as per the Composite Design Pattern from “Design Patterns”, Gamma. E, p 163. The classes and interfaces known to implement or inherit from the IBlock interface include IContainer, IAxis and IModel.

IClient 50: Manipulates objects in the composition through the IModel interface. This class is supplied by the user to provide client functionality.

IContainer 60: The IContainer interface is a derivative of Composite, as per the Composite Design Pattern from Design Patterns Book, p 163. The only interface known to derive from this interface is IModel.

IIdentifier 70: This is an interface which provides the attributes necessary for creating a unique identity for a IBlock or IPlace interface. When used by a IBlock, IContainer, IAxis or IModel instance, the name attribute refers to the name of the IBlock. When used by a IPlace instance, the name attribute is used to store the value of the Address field from IPlace.

IModel 80: This is a composite container structure with an axis system, that supports a variable number of Axes. The axis blocks provide coordinates for a IPlace instance, where a IBlock instance may be instantiated. The IPlace instance provides a unique key for the coordinate intersection of the axis values in a model. There are no variations of this element.

IPlace 90: The IPlace interface provides a Coordinates collection, which contains IBlock identifiers, which may be concatenated to form the Address field for the IPlace. The PlaceIdentifier is a IIdentifier instance derived from the address. The IPlace interface is implemented by the Place class.

Connections of Main Elements and Sub-Elements of Invention

An IBlock has an IIdentifier stored in a property named Identifier; A IPlace has an IIdentifier stored in a property named PlaceIdentifier; and a collection of references to IIdentifier instances stored in a property named Coordinates; A IAxis must have one or more IBlock instances stored in a property named AxisValues; A IPlace may have zero or one IBlock instances stored in a property named Instance; A IContainer instance may have zero or more IBlock instances in a collection stored in a property named Children, and for each IBlock instance in that collection, the Parent property for the IBlock instance is set to the container's instance; An IModel instance may contain zero or more IBlock instances stored in a property named Blocks; and has a Dictionary instance which collects IPlace instances indexed by their PlaceIdentifier instance, and stored in a property named PlacesTable; and has a collection of IAxis instances stored in a property named Axes.

Example Implementation

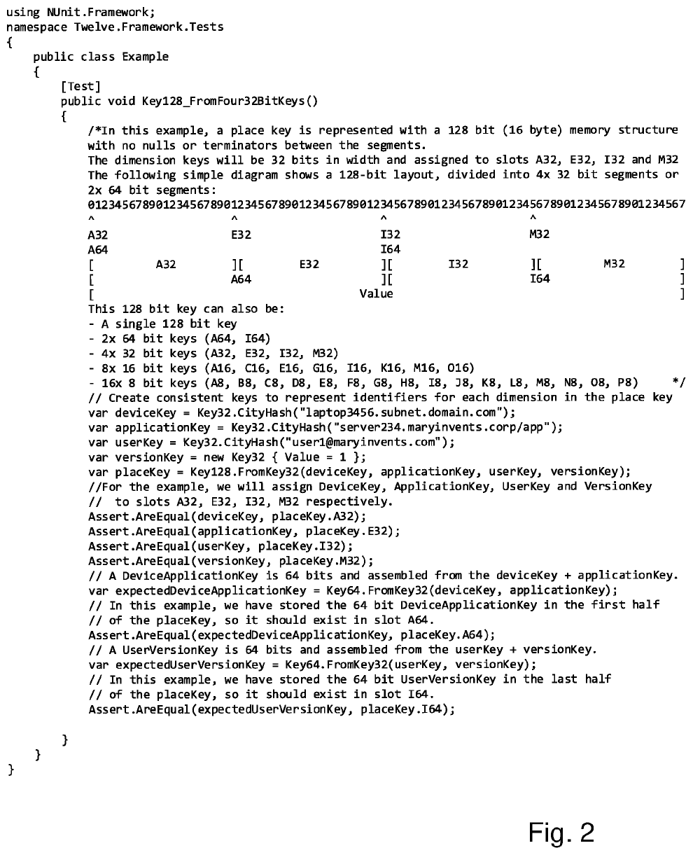

The source code listing in FIG. 2 illustrates an example implementation, written in C#, and may be compiled for .net framework core version 2.2. and tested using NUnit version 3. The listing illustrates the formation of a Place key represented by a 128 bit (16 byte) memory structure with no nulls or terminators between the segments. The dimension keys will be 32 bits in width and assigned to slots A32, E32, I32 and M32. The 128-bit layout can be divided into 4×32 bit segments or 2×64 bit segments: A32, E32, I32, M32; A64, I64. In alternative arrangements, the 128 bit key can also be: a single 128 bit key, 2×64 bit keys (A64, I64), 4×32 bit keys (A32, E32, I32, M32), 8×16 bit keys (A16, C16, E16, G16, I16, K16, M16, O16); or 16×8 bit keys (A8, B8, C8, D8, E8, F8, G8, H8, I8, J8, K8, L8, M8, N8, O8, P8).

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality.

It should be appreciated that in the above description of exemplary embodiments of the invention, various features of the invention are sometimes grouped together in a single embodiment, figure or description thereof for the purpose of streamlining the disclosure and aiding in the understanding of one or more of the various inventive aspects. This is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of creating an executable software object model including defined objects and instances for execution within a data container in a software environment, the method including the steps of:
(a) creating a first software object instance having a unique place key;
(b) creating a subsequent instance based on the first software object instance by utilization of the unique place key;
(c) storing the first and subsequent instances at positions utilizing the unique place key; and
(d) creating further data instances, in a current data container, and if a predetermined criterion applies, creating an instance with the unique place key in the current data container or an alternative data container.

2. A method as claimed in claim 1, wherein instances are matched at a place key location, where the place key location is at the intersection of two or more axis.

3. (canceled)

4. A software object model for use in a programming or operating system environment, the object model including:
a multi-dimensional coordinate system, where the coordinates may be object instances rather than numeric axis values.

5. A model as claimed in claim 4, wherein the coordinates intersect at a place, and the intersection of the coordinates at the place forms a unique key which may be used to reference objects at that address quickly and uniformly.

6. A model as claimed in claim 4, wherein access to the objects is via a hierarchical name space with the coordinate axes forming the hierarchy of the name space.

7. A model as claimed in claim 4, where the multi-dimensional coordinate system includes at least 1 axis.

8. A model as claimed in claim 4, wherein the number of dimensions are at least 10.

9. A model as claimed in claim 5, wherein access to the objects is via a hierarchical name space with the coordinate axes forming the hierarchy of the name space.

10. A model as claimed in claim 5, where the multi-dimensional coordinate system includes at least 1 axis.

11. A model as claimed in claim 5, wherein the number of dimensions are at least 10.

12. A model as claimed in claim 6, where the multi-dimensional coordinate system includes at least 1 axis.

13. A model as claimed in claim 6, wherein the number of dimensions are at least 10.

14. A model as claimed in claim 7, wherein the number of dimensions are at least 10.
